(19) United States
(12) Patent Application Publication
(10) Pub. No.: US 2010/0084881 A1
(43) Pub. Date: Apr. 8, 2010

(54) Pickup device for animal waste

(76) Inventor: Tony Patel, Naples, FL (US)

Correspondence Address: Tony Patel, P.O. Box 1491, Naples, FL, 34106, US

(21) Appl. No.: 12/286,704

(22) Filed: Oct. 2, 2008

(51) Int. Cl. A01K 29/00

(52) U.S. Cl. 294/1.4

(57) ABSTRACT

An animal waste pick-up device is disclosed which consists of two sliding sections which operate independently of each other. The first section is a sliding sleeve having two opposed flaps at one end thereof. The two opposed flaps will move into an open or closed position by operation of an operating knob on the outside of a housing. A second sliding sleeve is located within the first sliding sleeve and has at one end thereof two opposed and lateral catches. The lateral catches move to capture a waste pick-up box. The box consists of two opposed triangular sections that are used to pick up the animal waste. The opening and closing of the pick-up box is controlled by the movement of the two flaps which in turn are operated by the first sliding sleeve.

### BACKGROUND OF THE INVENTION

The invention pertains to an animal waste pickup device that can be used in an easy procedure and in a completely sanitary manner. Pet owners and other observers are quite familiar with city and other localities having ordinances that require pet owners, who take their pets for a walk, to pick up the pet's and animal's droppings such as feces to keep the environment in a sanitary condition. This ordinance, including common sense, applies to public properties as well as private properties. With the increased public concern over sanitation and a cleaner environment many municipalities have required dog owners to clean up after the animals have defecated on public as well as private properties. Although this is most pleasant for the public, it leaves the dog owner with an extremely unpleasant task. Many scooping devices have been provided to keep a bag open while the feces are scraped or scooped therein. Various devices are known to accomplish the above noted mandate. It is known to use plastic gloves that are worn on the hand which simply are used to manually pick up the droppings and inverting the glove or by stripping the glove off the hand to invert the same, the droppings can be disposed of in a sanitary manner. Others simply carry a small shovel and or a bucket or a similar container to accomplish the same task as noted above. Then, there are more complicated devices which accomplish the pick up and disposal of animal droppings in a completely sanitary manner.

U.S. Pat. No. 4,097,082 describes a device which accomplishes the above noted task. The implement described in this patent consists of an electrometric band to automatically close over the mouth of a flexible wrapper which is operated by two side plates that will swing inwardly at their bottoms to thereby grab the flexible wrapper having the animal dropping therein, to keep it therein and to thereafter dispose of the same, all in a sanitary manner.

U.S. Pat. No. 5,628,537 shows a similar device. This patent discloses a device which also uses a pair of jaws that are pivotally attached to one end of a long handle. An elongated sleeve is connected to the jaws around the handle. When the jaws are locked open, a bag clip engages the closed end of an ordinary thin plastic bag while the open end of the bag is inverted over the edges of the jaws. To pick up the dog feces, the user positions the open bag over the waste, makes the jaws contact the ground, rotates the sleeve to unlock a sliding motion and moves the sleeve downward on the handle. This closes the jaws and encloses the waste within the bag to be disposed of at a later time and in a sanitary manner.

U.S. Pat. No. 6,305,322, the applicant's own patent, discloses a waste pickup device consisting of an elongated tubular handle having an interior manipulator therein. At the end is a tubular casing. The interior handle van manipulate claws that can be retracted into the tubular casing. The claw consisting of four claws can receive a paper medium therein. The claws will pick up the feces and together with the paper is retracted to within the casing to thereby pick up the waste.

### BRIEF DESCRIPTION OF THE INVENTION

The inventive waste pick up device consists of at least two parts which are incorporated into a single handle. A first part is sleeve which slides in a housing and is operated by one operating knob on the outside of the housing. In front of the housing the first part has two flaps located at the end of the sliding sleeve. When the operating knob is activated, the two flaps open or close as the sleeve moves in and out of the housing. A second part is located within the sliding sleeve and itself slides in and out when a second operating knob located on the outside of the housing is operated. The second part at its forward end has two lateral catches which move toward or away from each other as the second operating knob is operated. This forward end is designed to catch a semi-rigid construction to open and close as the two flaps are operated. This movement of the semi-rigid construction will pick up the waste to be enclosed within itself or the waste may be expelled when the first operating knob opens the flaps so that the semi-rigid structure will be open and the waste may fall out.

### BRIEF DESCRIPTION OF THE DRAWINGS

FIG. 1 is a perspective view of the pickup device showing both operating knobs and a front end;

FIG. 2 is a side view of FIG. 1 and a cross section showing interior elements;

FIG. 3 is a detailed view of the front of the device;

FIG. 4A shows the semi-rigid structure in an open position;

FIG. 4B shows the semi-rigid structure in a closed position;

FIG. 5 shows the lateral catches opposed prior to catching the semi-rigid structure;

FIG. 6 is the same as FIG. 5 but after the semi-rigid structure after it has been caught;

FIG. 7 is a perspective and an exploded view of the various elements that are contained in the pickup device.

### DETAILED DESCRIPTION OF THE INVENTION

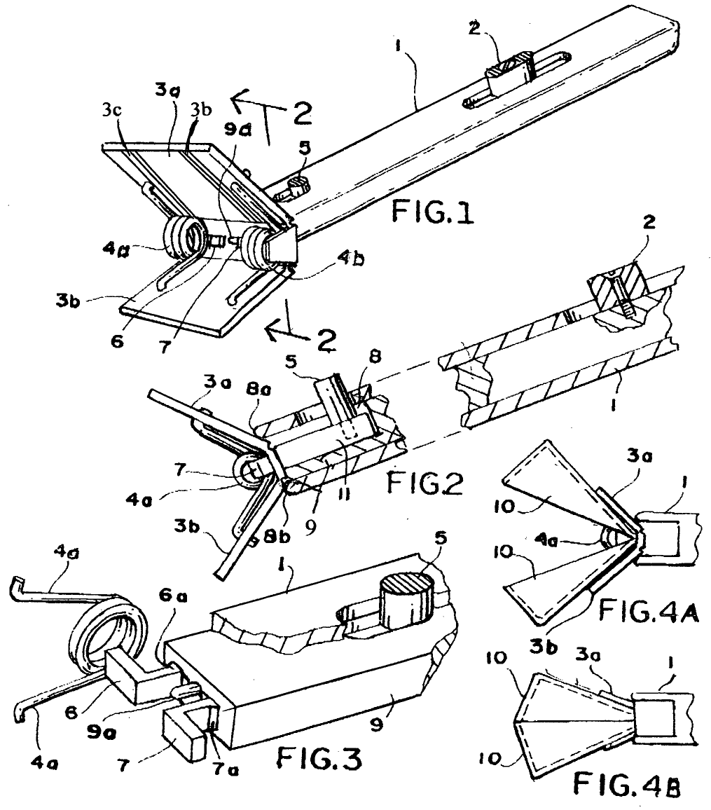

FIG. 1 is a perspective view of the pickup device. A housing is shown at 1. The housing has two operating systems therein. A first system is operated by an operating knob 2. The operating knob 2 operates a sliding sleeve 8 (not shown in FIG. 1) which has at its left end and on the outside of the housing 1 two movable flaps 3a and 3b. The two flaps 3a and 3b are held in its open position by way of two springs 4a and 4b. Within the sliding sleeve 8 there is a further sliding sleeve 9 which is operated by the second operating knob 5. The forward end of this second sliding sleeve 9 has at its forward end and in the bottom of the two flaps 3a and 3b two lateral and opposed catches 6 and 7 which will move relative to each other as will be explained below.

FIG. 2 is cross section and a side view of the device shown in FIG. 1. The housing again is shown at 1 and the first sliding sleeve is shown at 8 which is operated by the operating knob 2. On the left side of the housing FIG. 2 shows the two movable flaps 3a and 3b which are held in an open position by the springs 4a and 4b, only 4b is shown in FIG. 2. When the operating knob 2 moved to the left, for example, the first sliding sleeve will move to the left also. This movement causes the two flaps to cam against the outer perimeter of the housing 1 which is shown at 8a and 8b. This movement causes the two flaps 3a and 3b to pushed against each other and against the bias of the springs 4a and 4b. The result of this movement will be explained under the headline of “operation” below.

FIG. 2 also shows the second sliding sleeve 9 which slides in the first sliding sleeve 8 and is operated by the operating knob 5. As mentioned with regard to FIG. 1, the second sliding sleeve 9 has at its forward end two opposed catches 6 and 7. Only 7 is shown in FIG. 2. Also shown in FIG. 2 is the semi-rigid structure 10 shown in phantom prior to being inserted into and under the flaps 3a and 3b.

FIG. 3 is a detailed view of the forward end of the second slide 9. On the forward end of the slide 9 there are located the two lateral and opposed catches 6 and 7. They two catches are made of a flexible material so that they can flex in and out when commanded to do so. In this regard, when the second sliding sleeve 9 is moved to the right within the first sliding sleeve, the two camming surfaces 6a and 7a, one on each of the catches, encounter the edge of the sliding sleeve 9, whereby they will move toward each other. The result of this will be explained below. Also in this FIG. 3 there is shown the left spring 4a in phantom to create a mental picture of the location of the various elements.

FIGS. 4A and 4B show the movement of the flaps 3a and 3b. The semi-rigid construction 10 will now be explained. As can be seen in both Figs. The semi-rigid structure consists of two halves which are hinged to each other at their ends. Each half consists of triangular profiles which form a box-like structure when placed next to each other. The box-like structure is made of a light weight carton material to withstand the opening and closing forces by way of the flaps 3a and 3b when they are moved to or from each other. In FIG. 4A, the box-like structure is open because the flaps 3a and 3b have moved away from each other when the first slide was moved to the left and the springs 4a and 4b by way of their bias moved both flaps 3a and 3b away from each other. When the second slide 9 is moved to the right, the camming surfaces 8a and 8b (FIG. 2) move the flaps 3a and 3b toward each other to thereby, at the same time, will move the two have halves toward each other and will close the box-like structure. (FIG. 4B).

FIG. 5 illustrates a somewhat different embodiment with regard to the operation of the opposed lateral catches shown in FIG. 3. In this embodiment there is a single element 11 being made of a flexible plastic material. This element is mounted on a stationary pin 11a which in turn is mounted on the sliding sleeve 9. The sleeve 9 itself has spring 12 mounted so that the bias of this spring 12 can act on the flexible element when moved out and return it to the original position after having operated on by the operating knob 5 (FIGS. 1-3). The flexible element or clip 11 has again the two opposed and lateral catches 6 and 7 (see FIG. 3) that will cam against the opening of the sliding sleeve 9 by way of the camming surfaces 6a and 7a. During this movement, the two lateral and opposed catches 6 and 7 will move toward or away from each other. The result of this movement will be described below with reference to FIG. 7.

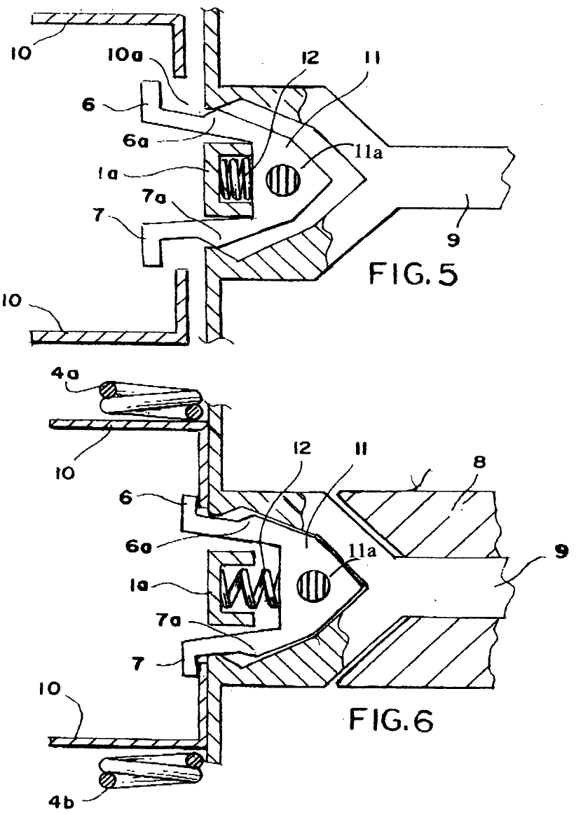

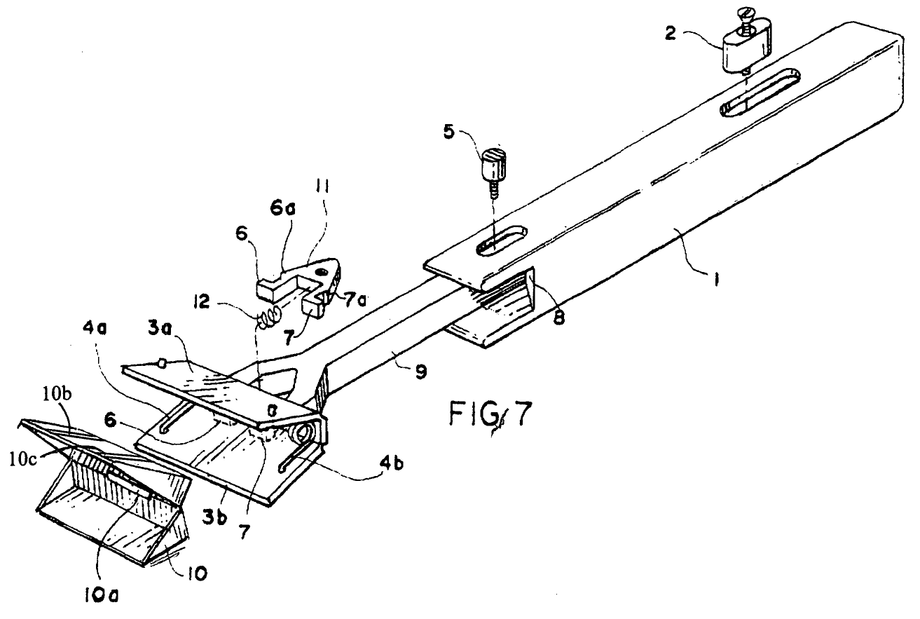

FIG. 6 shows the same illustration as shown in FIG. 5 except that the sliding sleeve 9 is in its rest position. In this Fig., as well as in FIG. 5, the collapsible box 10 is shown in phantom lines. In FIG. 5, the opposed lateral catches 6 and 7 have just penetrated into a slot in the back spine of the box 10, while in FIG. 6, the two opposed and lateral catches have secured the box within the confines of the flaps 3a and 3b. This is shown in FIG. 7.

FIG. 7 is an exploded view of the various elements shown in FIGS. 5 and 6. The housing 1 has the sliding sleeve 9 therein which will move under the closing flaps 3a and 3b when moved by sliding sleeve 8 which is operated by the knob 2 (FIGS. 1 and 2). On the left side of this Fig. there is shown the box 10 which consists of two triangular halves. (see also FIGS. 3A and 3B). In the back or the spine of this box there is slot 10a which is instrumental in being caught by the two opposed and lateral catches 6 and 7. (See FIGS. 5 and 6). The flexible element is shown at 11 and again shows the two lateral catches 6 and 7. At the front of the sliding sleeve 9 there are shown the two flaps 3a and 3b which when activated by the movement of the sliding sleeve 9, will open or close the pick up box 10 as will be described with reference to the operational description below.

### Operation

When it is desired to pick up an animal dropping, the sliding sleeve 9 is operated by the knob 5 and a pick box 10 is placed deep under the flaps 3a and 3b whereby the two lateral and opposed catches 6 and 7 will penetrate into the slot 10a in the spine of the box 10. Upon release of the sliding sleeve 9 the two lateral and opposed catches will move away from each other and thus capture the pick up box 10 there between. The device now is placed over the dropping and by moving the sliding sleeve 8 with the knob 2 into the tool, the dropping will be scraped from its location because the two flaps 3a and 3b are now closing the two triangular halves of the box to activate the scraping motion. The thus captured dropping may now be transported to its disposal site by pushing the sliding sleeve 8 in an opposite direction whereby the flaps 3a and 3b open because of the opening bias of the springs 4a and 4b. When the two flaps 3a and 3b open, so will the pick box 10 because of the ridges 3c and 3d on the flap 3a that have penetrated into the grooves 10 and 10c in the box 10. The box 10 will easily fall out from between the flaps 3a and 3b when opened and shaken and the droppings including the box 10 may be disposed of. The device is now ready for another use by using the same pick up box or replacing it with a new one. On the other hand if the implement is not shaken the box may remain attached to the flap 3a and only the droppings may be disposed of.

What I claim is:

1. An animal waste pick-up device comprising a handle having two sliding sections therein, a first section includes a first sliding sleeve in a housing, said first sliding sleeve having at one end thereof two opposed flaps thereon, means for opening or closing said opposed flaps by sliding said first sliding sleeve by a movement of said first sliding sleeve in a longitudinal direction within said housing, a second sliding section includes a second sliding sleeve located within said first sliding sleeve, said second sliding sleeve having at one end thereof means for engaging a normally open pick-up box, said pick-up box when closed will pick-up the animal waste.

2. The waste pick-up device of claim 1, wherein said two opposed flaps are normally biased into an position by a spring, said two opposed flaps are closed when said first sliding sleeve is moved into said housing whereby said two opposed flaps will be closed by being moved against a forward edge of said housing.

3. The waste pick-up device of claim 1, wherein said means for engaging said pick up includes two opposed and laterally positioned catches which are cammed into an open or closed position by being moved against forward edges of said second sliding sleeve.

4. The waste pick up device of claim 3, wherein said pick-up box consists of two opposed triangular sections being attached to each other by way of a spine, said spine having a slot therein, said opposed and lateral catches, when retracted into said second sliding sleeve, will enter said slit and capture said pick-up box when moved forward again.

5. The waste pick-up device of claim 1, wherein said first and said sliding sleeves are independently moved relative to each by operating knobs located on an outside of said housing.

6. The waste pick-up device of claim 1, wherein said second sliding sleeve is biased into said housing by way of a spring.
